(19) United States
(12) Patent Application Publication
(10) Pub. No.: US 2005/0041971 A1
(43) Pub. Date: Feb. 24, 2005

(54) Multi-wavelength optical transmitter and bi-directional wavelength division multiplexing system using the same

(76) Inventors: Jea-Hyuck Lee, Anyang-si (KR); Jeong-Seok Lee, Anyang-si (KR); Seong-Taek Hwang, Pyeongtaek-si (KR); Yun-Je Oh, Yongin-si (KR)

Correspondence Address: CHA & REITER, LLC, 210 ROUTE 4 EAST STE 103, PARAMUS, NJ, 07652, US

(21) Appl. No.: 10/792,322

(22) Filed: Mar. 3, 2004

(30) Foreign Application Priority Data
Aug. 23, 2003 (KR) 2003-58546

(51) Int. Cl. H04J 14/00

(52) U.S. Cl. 398/72

(57) ABSTRACT

A multi-wavelength optical transmitter which multiplexes a plurality of channels having different wavelengths into an optical signal for output includes lasers for generating mode-locked channels by corresponding incoherent light received in the lasers. The transmitter also has a semiconductor optical amplifier for amplifying, while in a gain saturation state, the optical signal multiplexed by the multiplexer/demultiplexer. Light from a broadband light source is directed by a circulator to the multiplexer/demultiplexer for demultiplexing among the lasers. Light back from the lasers is multiplexed and then directed by the circulator and amplified by a semiconductor optical amplifier for output external to the transmitter.

### CLAIM OF PRIORITY

This application claims priority to an application entitled “Multi-wavelength optical transmitter and bi-directional wavelength division multiplexing system using the same,” filed in the Korean Intellectual Property Office on Aug. 23, 2003 and assigned Serial No. 2003-58546, the contents of which are hereby incorporated by reference.

### BACKGROUND OF THE INVENTION

1. Field of the Invention

The present invention relates to a wavelength division multiplexing system, and more particularly to a wavelength division multiplexing system having a multi-wavelength light source, which can output light having a plurality of wavelengths different from each other.

2. Description of the Related Art

In a dual structure of a wavelength division multiplexed bi-directional passive optical network (hereinafter, referred to as a WDM-PON), a central office (CO) is connected to a remote node (RN) nearest to a subscriber side through a single-mode optical fiber, and a plurality of subscribers are connected to the remote node. Further, in the above-mentioned WDM, channels of certain wavelengths are assigned to the subscribers, so that an ultra high speed wideband communication network may be constructed between the central office and the subscribers.

As a result, security maintenance for each WDM subscriber is superior, and it is easy to expand a communication network.

In the WDM, a distributed feedback laser array (DFBL), a multi-frequency laser (MFL), and a spectrum-sliced light source have been proposed as a light source for generating a plurality of channels having different wavelengths.

In the spectrum-sliced light source, light having a wide wavelength band is divided into a plurality of channels having different wavelengths by a wavelength division multiplexer filter (WDM filter) or an arrayed waveguide grating (AWG) type wavelength division multiplexer/demultiplexer, and then the divided channels are outputted. Accordingly, the spectrum-sliced light source can output channels having different wavelengths, but does not need separate means for wavelength stabilization.

A light emitting diode, a super luminescent diode, a multi-mode Fabry-Perot laser, an optical fiber amplifier doped with a rare-earth element, or an ultra-short pulse light source may be used as the spectrum-sliced light source.

Although multi-mode Fabry-Perot lasers are low-priced, high power devices, their usable wavelength band is narrow which largely limits the number of usable channels. Moreover, although light sources such as optical fiber amplifiers doped with rare-earth elements and light emitting diodes as described above output incoherent light having a wide wavelength band, and thus create more divisible channels in comparison with multi-mode Fabry-Perot lasers, they cannot output high power light like multi-mode Fabry-Perot lasers.

The spectrum-sliced light source is limited in transmission distance and speed, due to mode partition noise generated between channels when light having a wide wavelength band is divided into channels having different wavelengths, the divided channels are modulated at high speed, and the modulated channels are transmitted.

### SUMMARY OF THE INVENTION

The present invention has been made to solve the above-mentioned problems occurring in the prior art, and an object of the present invention is to provide a stable multi-wavelength optical transmitter which can be employed in a wavelength division multiplexing system having stable transmission distance and transmission speed.

In order to accomplish the aforementioned objects, according to one aspect of the present, there is provided a multi-wavelength optical transmitter for multiplexing a plurality of channels having different wavelengths into an optical signal for output. The multi-wavelength optical transmitter includes lasers for generating, by corresponding incoherent light received in the lasers, mode-locked channels having different wavelengths. Further included is a multiplexer/demultiplexer for multiplexing the channels into an optical signal for output. A semiconductor optical amplifier (SOA) amplifies the outputted optical signal in a gain saturation state.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram showing a construction of a multi-wavelength optical transmitter according to a first embodiment of the present invention;

FIG. 2 is a graph showing a wavelength distribution of multi-wavelength light including a plurality of channels, generated by its own resonance before a mode-lock is performed in the laser shown in FIG. 1;

FIG. 3 is a graph showing incoherent light inputted to order to induce a mode-locked channel to the laser shown in FIG. 1;

FIG. 4 is a view showing a waveform of a channel generated by a mode-lock in the laser shown in FIG. 1;

FIG. 5 is a view showing an example of the prior art compared with the present invention, and a graph showing a noise characteristic of multi-mode channels;

FIG. 6 is a graph showing a noise characteristic of a channel generated by a mode-lock in the laser shown in FIG. 1;

FIG. 7 is a graph showing variation of relative intensity noise of an multiplexed optical signal, which is inputted to a gain saturation region of the SOA shown in FIG. 1, and an multiplexed optical signal amplified by the SOA;

FIG. 8 is a comparison example of the present invention and the prior art, which is a graph comparing a bit error rate of the present invention with a bit error rate of the prior art; and

FIG. 9 is a block diagram showing a construction of a bi-directional wavelength division multiplexing system including a multi-wavelength optical transmitter according to a second preferred embodiment of the present invention.

### DETAILED DESCRIPTION OF THE PREFERRED EMBODIMENT

Preferred embodiments according to the present invention are described below with reference to the accompanying drawings. In the following description of the present invention, detailed description of known functions and configuration is omitted for clarity of presentation.

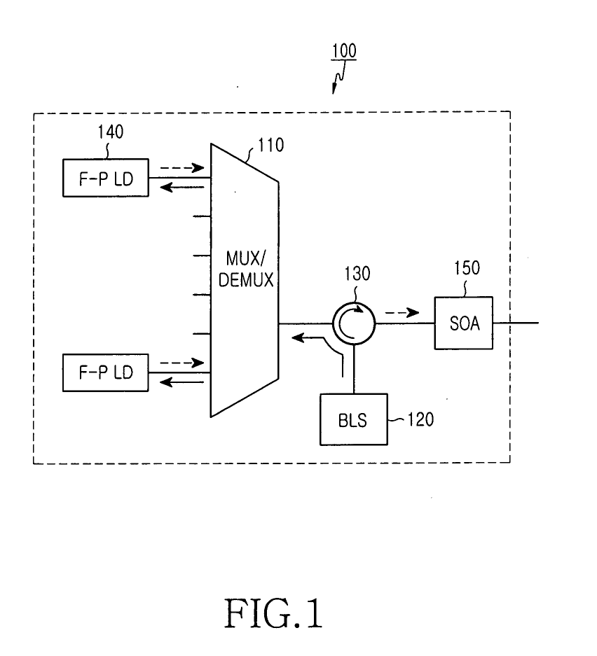

FIG. 1 is a block diagram showing a construction of a multi-wavelength optical transmitter according to a first embodiment of the present invention. Referring to FIG. 1, the multi-wavelength optical transmitter 100, which multiplexes a plurality of channels having different wavelengths into an optical signal and outputs the multiplexed optical signal includes a plurality of lasers 140, a multiplexer/demultiplexer 110, an SOA 150, a broadband light source (hereinafter, referred to as a BLS) 120, and a circulator 130.

The BLS 120 outputs light having a wide wavelength band. Light is demultiplexed by the multiplexer/demultiplexer 110 into a plurality of incoherent lights having different wavelengths for input to the lasers 140. The BLS 120 can include an optical fiber amplifier doped with a rare-earth element or a light emitting diode.

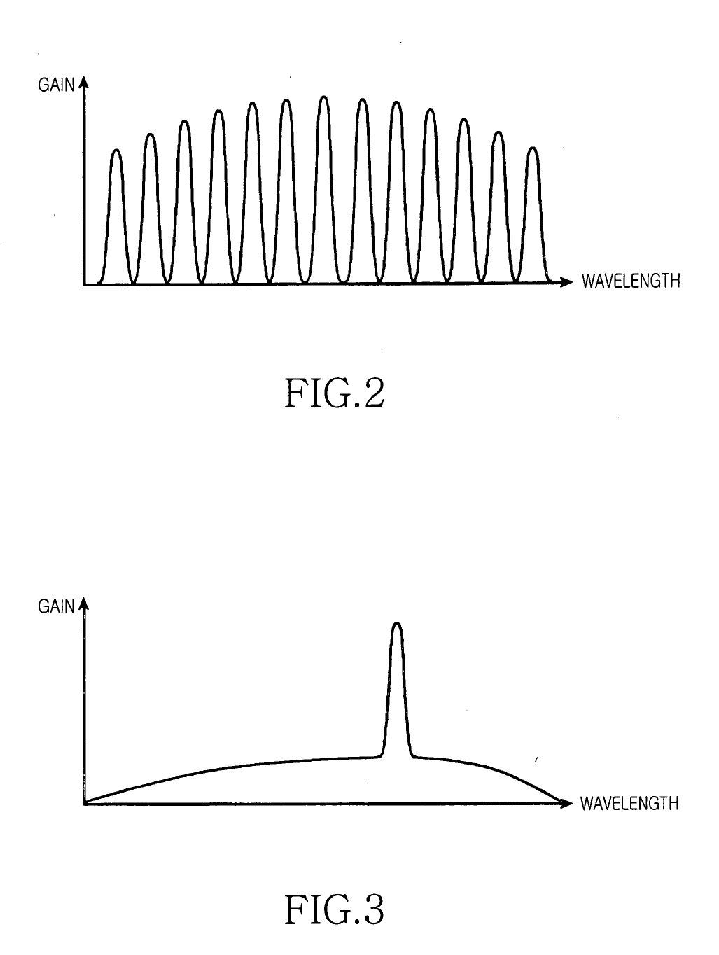

FIGS. 2 to 4 are graphs showing operation processes through which the lasers shown in FIG. 1 generate mode-locked channels. Each of the lasers 140 generates the mode-locked channel by corresponding incoherent light received in the lasers 140. The lasers 140 can include Fabry-Perot lasers, etc.

Referring to FIG. 2, a laser such as the Fabry-Perot laser has a resonance characteristic in that it generates channels λ₋ₙ to λₙ having wavelengths different from each other which fall within a predetermined wavelength band.

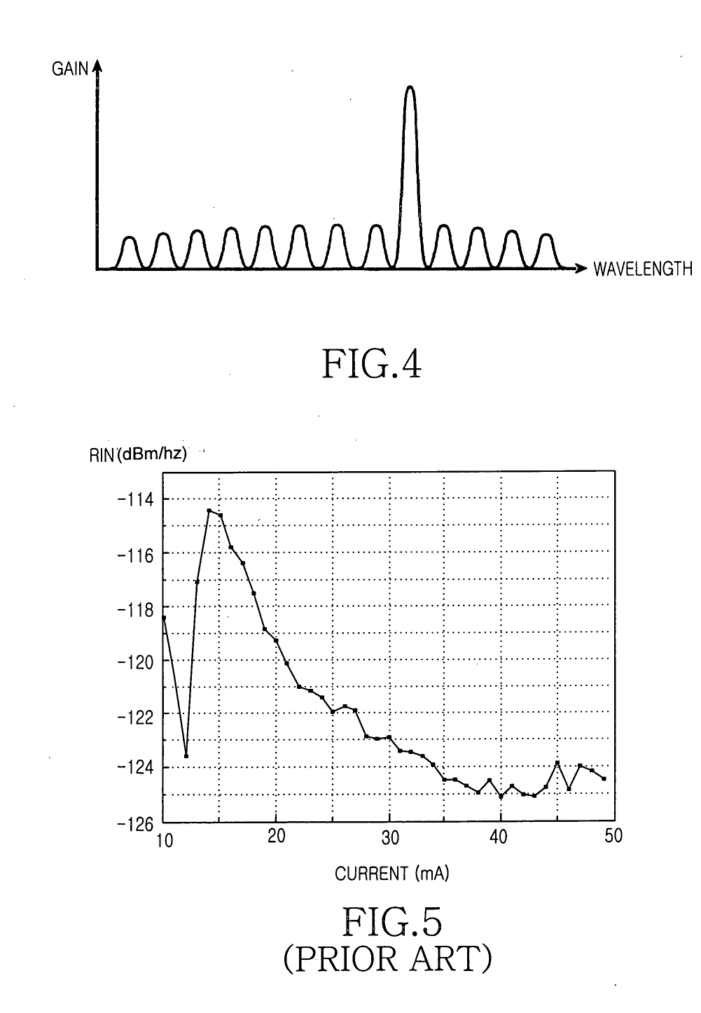

Referring to FIGS. 3 to 4, the Fabry-Perot laser displays a mode-lock characteristic in that it outputs to its exterior a channel λ₀ of a wavelength, which coincides with a wavelength λ₀ of incoherent light received in the Fabry-Perot laser, from among the plurality of channels λ₋ₙ to λₙ. That is, in the Fabry-Perot laser, the intensity of channels around the channel λ₀ generated by the mode-lock is suppressed, so that transmission performance is prevented from being deteriorated by the conventional mode partition noise and dispersion effect of an optical fiber.

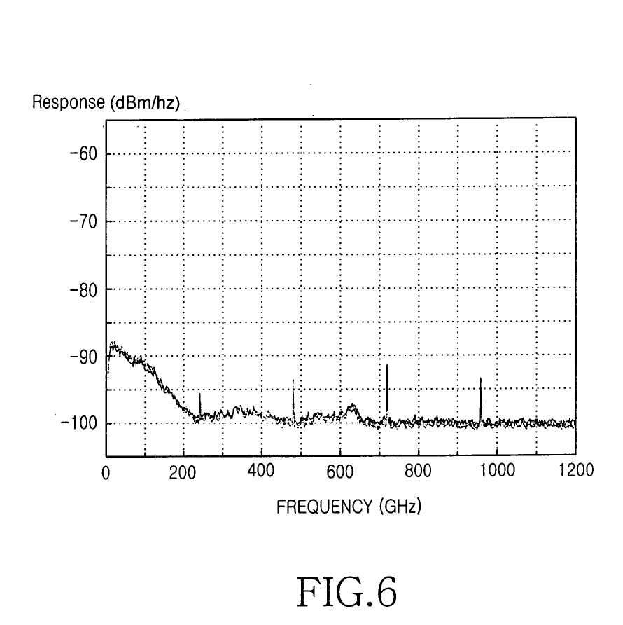

FIG. 5 is a graph showing a noise characteristic of multi-mode channels according to an example of the prior art for comparison of the present invention with the prior art, and FIG. 6 is a graph showing a noise characteristic of a channel generated by a mode-lock in the laser shown in FIG. 1.

Referring to FIGS. 5 and 6, the conventional Fabry-Perot laser exhibits noise within a range of about −120˜−130 dBm/Hz (decibels per milliwatt per “hertz” or “cycle”). In contrast, a mode-locked channel applied to the present invention has a noise of about −100˜−110 dBm/Hz. Noise, as illustrated in the graphs, is increased in the present invention.

Further, in the channel λ₀ generated by the mode-lock as described above, a side mode suppression ratio (SMSR), which is an intensity difference between suppressed channels around the channel, increases, so that a transmission performance of the channel is prevented from deteriorating. Furthermore, multiplexed optical signals are amplified by the SOA 150 in a gain saturation state, so that relative intensity noise due to intensity difference between each channel is also reduced.

The multiplexer/demultiplexer 110 multiplexes the mode-locked channels generated by the lasers 140 into an optical signal so as to output the multiplexed signal to the circulator 130. Further, the multiplexer/demultiplexer 110 demultiplexes light of the wide wavelength band received in the circulator 130 into a plurality of incoherent lights having different wavelengths, and outputs demultiplexed light to a corresponding laser 140. An arrayed waveguide grating may be used as the multiplexer/demultiplexer 110.

Three ports of the circulator 130 are respectively connected to the SOA 150, the multiplexer/demultiplexer 110, and the BLS 120. The circulator 130 outputs the multiplexed optical signal, which is outputted from the multiplexer/demultiplexer 110, to the SOA 150, and outputs light having the wide wavelength band received in the BLS 120 to the multiplexer/demultiplexer 110.

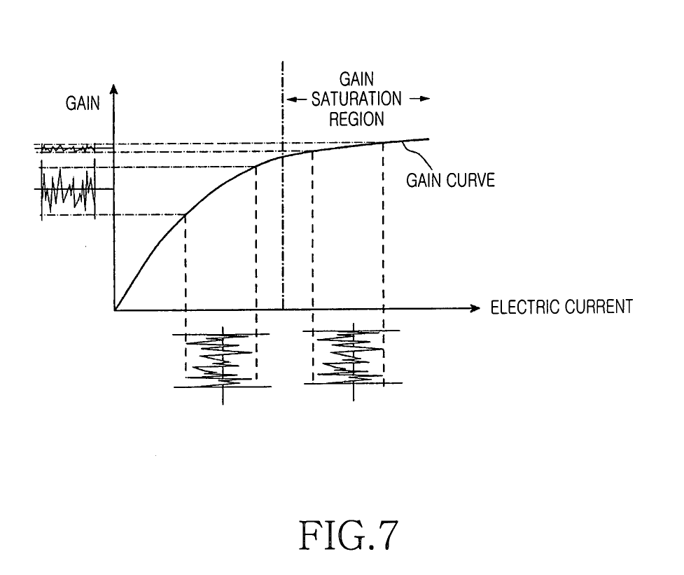

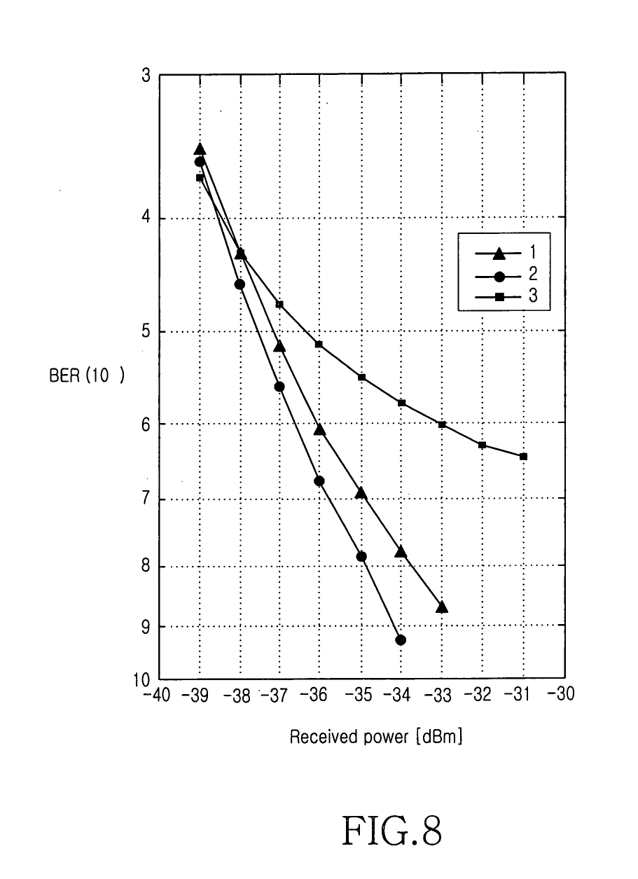

FIG. 7 is a graph showing variation of relative intensity noise of a multiplexed optical signal inputted to a gain saturation region of the SOA shown in FIG. 1 and a multiplexed optical signal amplified by the SOA. FIG. 8 is a comparison example of the present invention and the prior art, which is a graph comparing a bit error rate of the present invention with a bit error rate of the prior art.

Referring to FIG. 7, the SOA 150 amplifies the multiplexed optical signal outputted from the circulator 130 so as to output the amplified optical signal. The SOA 150 has a general region and a gain saturation region. In the general region, intensity of the amplified optical signal gradually increases according to power of the multiplexed optical signal. In the gain saturation region, an amplification rate of the amplified optical signal with respect to the received optical signal is smaller than that in the general region.

The gain saturation region results from the phenomenon wherein, as the power of an optical signal inputted to the SOA 150 increases, the quantity of electric charge consumed by a stimulated emission of charges supplied to the SOA 150 exceeds the quantity of electric charge supplied to the SOA 150.

The gain saturation region of the SOA 150 can be formed by enabling the power of an optical signal received in the amplifier to nearly reach a maximum amplification capacity of the SOA 150, or by increasing driving current applied to the SOA 150.

That is, according to the present invention, the SOA 150 operates in the gain saturation region, so that the mode-locked channels received in amplifier 150 minimize relative intensity noise of the multiplexed optical signal.

FIG. 8 is a graph for comparing, for the SOA 150, three channels with each other as to bit per error rates, i.e. the number of bits on average generated before an error arises. FIG. 8 shows first channel (1; ▴), to which driving current of 100 mA is applied with SOA 150 in a gain saturation state, a second channel (2; ●) to which driving current of 200 mA is applied while the SOA is in a gain saturation state, and a third channel representing the conventional general light source (3; ▪). As shown, the bit per error rates of the channels of the SOA 150 to which driving currents of 100 mA and 200 mA are respectively applied, while the SOA is in a gain saturation state, exceed those of the conventional general light source. That is, at noise of −34 dBm, the channel outputted from the conventional light source shows a bit per error rate between 6˜5. In contrast, according to the present invention, when driving current of 200 mA is applied, the channel outputted from the SOA 150 shows a bit per error rate between 10˜9. Further, even when driving current of merely 100 mA is applied, the channel outputted from the SOA 150 shows a bit per error rate between 9˜8.

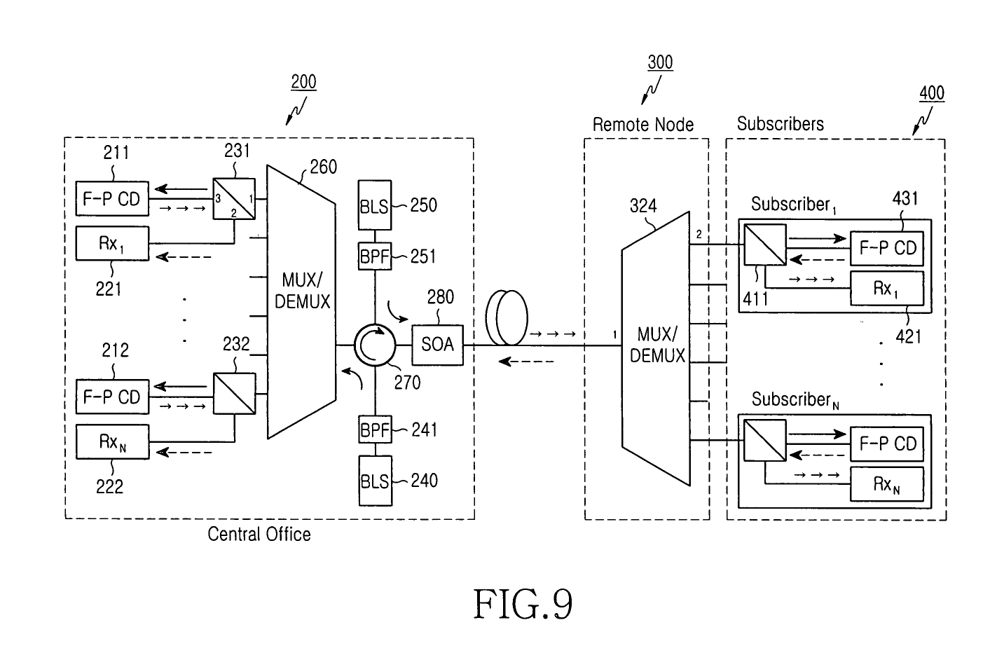

FIG. 9 is a block diagram showing a construction of a bi-directional wavelength division multiplexing system including a multi-wavelength optical transmitter according to a second preferred embodiment of the present invention. Referring to FIG. 9, the bi-directional wavelength division multiplexing system includes a central office 200, a plurality of subscriber terminals or “subscribers” 400, and a remote node 300. The central office 200 outputs a downstream optical signal and detects upstream channels, the plurality of subscribers 400 detect downstream channels and output the upstream channels, and the remote node 300 relays optical communication between the central office 200 and the subscribers 400.

The central office 200 includes a downstream BLS 240 for outputting downstream light, an upstream BLS 250 for outputting upstream light, a multiplexer/demultiplexer 260 for multiplexing a plurality of downstream channels into a downstream optical signal, a circulator 270, a first band pass filter 241, a second band pass filter 251, a plurality of photodetectors 221, 222 for detecting demultiplexed upstream channels, a plurality of lasers including lasers 211, 212, an SOA 280, and a plurality of wavelength selection couplers (WSCs) including WSCs 231, 232. The plural lasers and WSCs will be described below with reference, in particular, to the lasers 211, 212 and the WSCs 231, 232, respectively.

The downstream BLS 240 outputs downstream light having a wide wavelength band, and the upstream BLS 250 outputs upstream light. Downstream light comprises incoherent lights having different wavelengths in a wavelength band of 1550 nm, so that the central office 200 can output mode-locked downstream channels to be transmitted to each of the subscribers 400. In contrast, upstream light comprises incoherent light having different wavelengths in a wavelength band of 1310 nm, so that each of the subscribers 400 can output mode-locked upstream channels to the central office 200. An optical fiber amplifier doped with a rare-earth element or a light emitting diode can be used as the downstream and the upstream BLS 240, 250.

The lasers 211, 212 generate the mode-locked downstream channels by corresponding incoherent light received in the lasers 211, 212, and output the generated mode-locked downstream channels to the multiplexer/demultiplexer 260. Fabry-Perot lasers can be used as the lasers.

The multiplexer/demultiplexer 260 demultiplexes an upstream optical signal outputted from the remote node 300 into a plurality of upstream channels having different wavelengths, and outputs the demultiplexed upstream channels. Further, the multiplexer/demultiplexer 260 multiplexes the downstream channels outputted from each of the lasers 211, 212 into a downstream optical signal, and outputs the multiplexed optical signal. The downstream optical signal uses the same wavelength band as that of downstream light, and an arrayed waveguide grating, etc., can be used as the multiplexer/demultiplexer 260. Further, the multiplexer/demultiplexer 260 demultiplexes downstream light into a plurality of incoherent lights having different wavelengths, and outputs demultiplexed light to each of the WSCs 231, 232.

The WSCs 231, 232 send the upstream optical signal, which is outputted from the multiplexer/demultiplexer 260, to a corresponding photodetector 221, 222. The WSCs 231, 232 output demultiplexed incoherent light to a corresponding laser 211, 212, and output downstream channels, which are outputted from the corresponding laser to the multiplexer/demultiplexer 260.

The photodetectors 221, 222 detect each of the upstream channels outputted from the wavelength selection couplers 231, 232. A light receiving element such as a photo diode can be used as the photodetectors.

The SOA 280 amplifies the upstream optical signal and the downstream optical signal, which are received in the amplifier 280, in a gain saturation state, so as to output the amplified upstream optical signal to the multiplexer/demultiplexer 260, to output the amplified downstream optical signal to the remote node 300.

The circulator 270 is located between the multiplexer/demultiplexer 260 and the SOA 280, so that the circulator 270 outputs the upstream optical signal and downstream light to the multiplexer/demultiplexer 260, and outputs the downstream optical signal and upstream light to the SOA 280.

The first band pass filter (BPF) 241 is located between the downstream BLS 240 and the circulator 270, so that the first BPF reflects to the circulator an upstream optical signal received in the first BPF, and transmits downstream light to the circulator.

The second BPF 251 is located between the upstream BLS 250 and the circulator 270, so that the second BPF reflects to the circulator a downstream optical signal received in the second BPF, and transmits upstream light to the circulator.

The remote node 300 includes a multiplexer/demultiplexer 324. The multiplexer/demultiplexer 324 demultiplexes upstream light outputted from the central office 200 into a plurality of incoherent lights having different wavelengths and demultiplexes the downstream optical signal into a plurality of downstream channels having different wavelengths. The multiplexer/demultiplexer 324 also outputs demultiplexed incoherent light and downstream channels to the subscribers 400. Further, the multiplexer/demultiplexer 324 multiplexes the upstream channels outputted from each of the subscribers 400 into an upstream optical signal so as to output the multiplexed optical signal to the central office 200. An arrayed waveguide grating can be used as the multiplexer/demultiplexer 324.

Each of the subscribers 400 includes a laser 431, a photodetector 421, and a WSC 411. The laser 431 outputs a mode-locked upstream channel by corresponding incoherent light, and the photodetector 421 detects a corresponding downstream channel outputted from the remote node 300.

The laser 431 includes a Fabry-Perot laser, etc., and the photodetector 421 includes a light-receiving element such as a photo diode.

The WSC 411 sends the upstream channel, which is outputted from the laser 431, to the remote node 300, and sends the downstream channel, which is outputted from the remote node 300, to the photodetector 421. The WSC 411 outputs corresponding incoherent light, which is outputted from the remote node 300, to the laser 431.

As described above, according to the present invention, an optical signal, into which a plurality of mode-locked channels are multiplexed, is amplified by an SOA in a gain saturation state, so that mode partition noise due to a partition of each channel is compensated. As a result, loss of each channel due to the mode partition noise is compensated, yielding an improvement in transmission speed and transmission distance.

While the invention has been shown and described with reference to certain preferred embodiments thereof, it will be understood by those skilled in the art that various changes in form and details may be made therein without departing from the spirit and scope of the invention as defined by the appended claims.

1. A multi-wavelength optical transmitter for multiplexing a plurality of channels having different wavelengths into an optical signal so as to output the multiplexed optical signal, the multi-wavelength optical transmitter comprising:
a plurality of lasers for generating, by corresponding incoherent light received in the lasers, a plurality of mode-locked channels having different wavelengths;
a multiplexer/demultiplexer for multiplexing the plural channels into an optical signal for output; and
a semiconductor optical amplifier (SOA) for amplifying the outputted optical signal in a gain saturation state.

2. The multi-wavelength optical transmitter as claimed in claim 1, further comprising:
a broadband light source for generating light having a wide wavelength band including a plurality of incoherent lights having different wavelengths; and
a circulator for outputting the multiplexed optical signal to the SOA, and sending light that is outputted from the broadband light source to the multiplexer/demultiplexer,
wherein the multiplexer/demultiplexer demultiplexes said light that is outputted from the broadband light source into a plurality of incoherent lights having different wavelengths so as to output the demultiplexed incoherent light among the lasers.

3. The multi-wavelength optical transmitter as claimed in claim 2, wherein the broadband light source includes an Erbium-doped fiber amplifier.

4. The multi-wavelength optical transmitter as claimed in claim 1, wherein the multiplexer/demultiplexer includes an arrayed waveguide grating.

5. The multi-wavelength optical transmitter as claimed in claim 1, wherein the lasers include a Fabry-Perot laser for generating a respective mode-locked channel by incoherent light.

6. A bi-directional wavelength division multiplexing system comprising a central office for outputting a downstream optical signal comprised of downstream channels and for receiving upstream channels, a plurality of subscriber terminals for receiving said downstream channels and outputting said upstream channels, and a remote node for relaying optical communication between the central office and the subscriber terminals, wherein the central office includes:
a multiplexer/demultiplexer for demultiplexing an upstream optical signal into said upstream channels so as to output the demultiplexed channels, and multiplexing a plurality of downstream channels having different wavelengths into said downstream optical signal so as to output the multiplexed optical signal;
a plurality of photodetectors for detecting each of said upstream channels demultiplexed by the multiplexer/demultiplexer;
a plurality of lasers for generating mode-locked downstream channels by corresponding incoherent light received in the lasers, and outputting the generated downstream channels to the multiplexer/demultiplexer;
a semiconductor optical amplifier for amplifying the upstream optical signal to be demultiplexed and the downstream optical signal to be outputted by the central office, which are received in the semiconductor optical amplifier in a gain saturation state, so as to output the amplified upstream optical signal to the multiplexer/demultiplexer and so as to output the amplified downstream optical signal to the remote node; and
a plurality of wavelength selection couplers for outputting ones of said upstream channels, which are outputted from the multiplexer/demultiplexer, to corresponding photodetectors, outputting corresponding incoherent light to corresponding lasers, and outputting said downstream channels, which are outputted from the lasers, to the multiplexer/demultiplexer.

7. The bi-directional wavelength division multiplexing system as claimed in claim 6, wherein the central office further comprises:
a downstream broadband light source for outputting downstream light having a wide wavelength band including a plurality of incoherent lights having different wavelengths;
an upstream broadband light source for outputting upstream light having a wide wavelength band including a plurality of incoherent lights having different wavelengths;
a circulator located between the multiplexer/demultiplexer and the SOA, for outputting the upstream optical signal and downstream light to the multiplexer/demultiplexer, and for outputting the downstream optical signal and upstream light to the semiconductor optical amplifier;
a first band pass filter (BPF) located between the downstream broadband light source and the circulator, for reflecting an upstream optical signal received in the first BPF to the circulator, and for transmitting downstream light to the circulator; and
a second BPF located between the upstream broadband light source and the circulator, for reflecting a downstream optical signal received in the second BPF to the circulator, and for transmitting upstream light to the circulator,
wherein the multiplexer/demultiplexer demultiplexes downstream light into a plurality of incoherent lights having different wavelengths so as to output demultiplexed light to each of the wavelength selection couplers.

8. The bi-directional wavelength division multiplexing system as claimed in claim 7, wherein the downstream broadband light source uses an Erbium doped fiber amplifier outputting spontaneous emission light in a wavelength band of 1550 nm.

9. The bi-directional wavelength division multiplexing system as claimed in claim 7, wherein the upstream broadband light source uses an Erbium doped fiber amplifier outputting spontaneous emission light in a wavelength band of 1310 nm.

10. The bi-directional wavelength division multiplexing system as claimed in claim 6, wherein the lasers include Fabry-Perot lasers.

11. The bi-directional wavelength division multiplexing system as claimed in claim 6, wherein the remote node includes a multiplexer/demultiplexer for multiplexing said upstream channels outputted from each of the subscriber terminals into said upstream optical signal for output to the central office, demultiplexing upstream light outputted from the central office into a plurality of incoherent lights having different wavelengths so as to output the demultiplexed upstream light to a corresponding subscriber terminal, and demultiplexing said downstream optical signal into said plurality of downstream channels for output to corresponding ones of the plural subscriber terminals.

12. The bi-directional wavelength division multiplexing system as claimed in claim 6, wherein the remote node includes a multiplexer/demultiplexer for demultiplexing upstream light and a downstream optical signal each for output to the subscriber terminals, the multiplexer/demultiplexer of the remote node multiplexing a plurality of upstream channels having different wavelengths, which are outputted from the subscriber terminals, into said upstream optical signal for transmission to the central office.

13. The bi-directional wavelength division multiplexing system as claimed in claim 12, wherein the multiplexer/demultiplexer of the remote node uses an arrayed waveguide grating demultiplexing upstream light received in the multiplexer/demultiplexer of the remote node into a plurality of incoherent lights having different wavelengths, demultiplexing said downstream optical signal into said plurality of downstream channels, and outputting the demultiplexed downstream channels and incoherent light to the subscriber terminals.

14. The bi-directional wavelength division multiplexing system as claimed in claim 6, wherein each of the subscriber terminals comprises:
a laser for generating a mode-locked upstream channel by corresponding incoherent light so as to output the generated mode-locked upstream channel;
a photodetector for detecting a corresponding one of the downstream channels; and
a wavelength selection coupler for outputting the mode-locked upstream channel to the remote node, outputting said corresponding one of the downstream channels, which is outputted from the remote node, to the photodetector, and outputting to the laser said corresponding incoherent light.

15. The bi-directional wavelength division multiplexing system as claimed in claim 14, wherein the lasers include Fabry-Perot lasers.

16. A method for multiplexing comprising the steps of:
generating, by corresponding incoherent light received, a plurality of mode-locked channels having different wavelengths;
multiplexing the plural channels into an optical signal for output;
receiving the optical signal; and
amplifying, in a gain saturation state, the received optical signal.

17. The method as claimed in claim 16, further comprising the steps of:
generating light having a wide wavelength band including a plurality of incoherent lights having different wavelengths; and
outputting the multiplexed optical signal for said amplifying, and sending the generated light source for demultiplexing into a plurality of incoherent lights having different wavelengths so as to output the demultiplexed incoherent light among lasers.

18. The method as claimed in claim 17, wherein said generating light having a wide wavelength band is performed by a broadband light source that includes an Erbium-doped fiber amplifier.

19. The method as claimed in claim 16, wherein the multiplexing is performed by a multiplexer/demultiplexer that includes an arrayed waveguide grating.

20. The method as claimed in claim 16, wherein the generating is performed by lasers that include a Fabry-Perot laser for generating a respective mode-locked channel by incoherent light.
